(19) United States
(12) Patent Application Publication
(10) Pub. No.: US 2018/0332175 A1
(43) Pub. Date: Nov. 15, 2018

(54) MOBILE PREPAID SOLUTION FOR ENERGY METERING

(71) Applicant: Honeywell International Inc., Morris Plains, NJ (US)

(72) Inventors: Valentin Suta, Giarmata (RO); Ionut Nicorescu, Timisoara (RO); Lucian Timar, Dumbravita (RO); Razvan Trif, Timisoara (RO); Sam Fenton, Glenwood (AU); Balamurugan Venkatesh, Hosur (IN); Peter Dependahl, Wiesbaden (DE); Cristian-Cornel Cucuiet, Timisoara (RO)

(21) Appl. No.: 15/979,102

(22) Filed: May 14, 2018

(30) Foreign Application Priority Data
May 15, 2017 (IN) 201741016975

(51) Int. Cl. H04M 15/28; G06Q 50/06; G06Q 20/28; H04M 15/00; H04W 4/24

(52) U.S. Cl. CPC H04M 15/28; G06Q 50/06; H04W 4/24; H04M 15/43; G06Q 20/28

(57) ABSTRACT

A metering system for metering consumption of a commodity. The metering system enalbing mobility based prepaid solution and event notification for energy metering. The metering system comprising a prepaid metering device, a mobile device, and a head-end system. The mobile device includes a mobile application configured to communicate with the meter and the head-end system to monitor, diagnose, register, and add credit to the prepaid metering device. The mobile application provides an automated solution for managing prepaid metering devices.

### CROSS-REFERENCE TO RELATED APPLICATION

This application claims priority from India Application No. 201741016975 filed May 15, 2017, the contents of which cited application are hereby incorporated by reference in its entirety.

### TECHNICAL FIELD

The present invention relates to a metering system and process, and more particularly, to systems and processes for enabling mobility based prepaid solutions and event notifications for prepaid energy metering.

### BACKGROUND

Prepaid metering systems require an advance payment before electricity can be used. If the credit for the prepaid metering system has exhausted, then the supply of electricity is cut off by, for example, a relay. The procedures and processes for procuring credit vouchers to “top up” prepaid metering systems can be cumbersome and may require manual entry at the meter.

The foregoing background discussion is intended solely to aid the reader. It is not intended to limit the innovations described herein. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

An improved prepaid metering system and process for installing a prepaid metering system is desired to more efficiently monitor functional operation and to automate adding credit to the prepaid meter.

Lack of automated prepaid solution for energy metering can enable end user driven read out using the public networks and infrastructure.

In conventional prepaid metering systems, cumbersome procedures and processes are required to add credit to the meter. For example, end users have to manually enter information at the meter using multiple key entries with minimal human machine interface (HMI) options available. Any wrong entry or mistype would lead to the end user having to go through the process of manually entering the information again and thereby annoying the user experience.

Moreover, conventional prepaid metering systems require utility companies to set their own monitoring infrastructure to read meter data and expensive radio stations to monitor the meters. Monitoring or diagnostics of meters that have been tampered with and/or tripped off from incoming power due to credit overdue would result in deploying of a meter technician assess the meter and/or surroundings at the meter location.

There has been a rising trend of technical power loss due to a lack of monitoring systems. For example, 80% of electricity supplied to residents of Soweto is stolen or unpaid, and 32% of electricity in Johannesburg is lost to non-payment.

This summary is provided to introduce a selection of concepts in a simplified form that are further described below in the Detailed Description section. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

### BRIEF DESCRIPTION OF THE DRAWINGS

A more detailed understanding may be had from the following description, given by way of example in conjunction with the accompanying drawings, wherein:

FIGS. 1-2 illustrate aspects of a metering system in which systems, processes, and apparatus disclosed herein may be embodied.

### DETAILED DESCRIPTION

The disclosure relates generally to prepaid metering systems and processes for monitoring, installing, registering, or otherwise assessing a prepaid metering system. Although the system and processes are described herein in the context of a system for metering electrical energy consumption, it is understood that the system and processes described herein may be implemented in systems that monitor consumption of other commodities, such as, for example, water or gas.

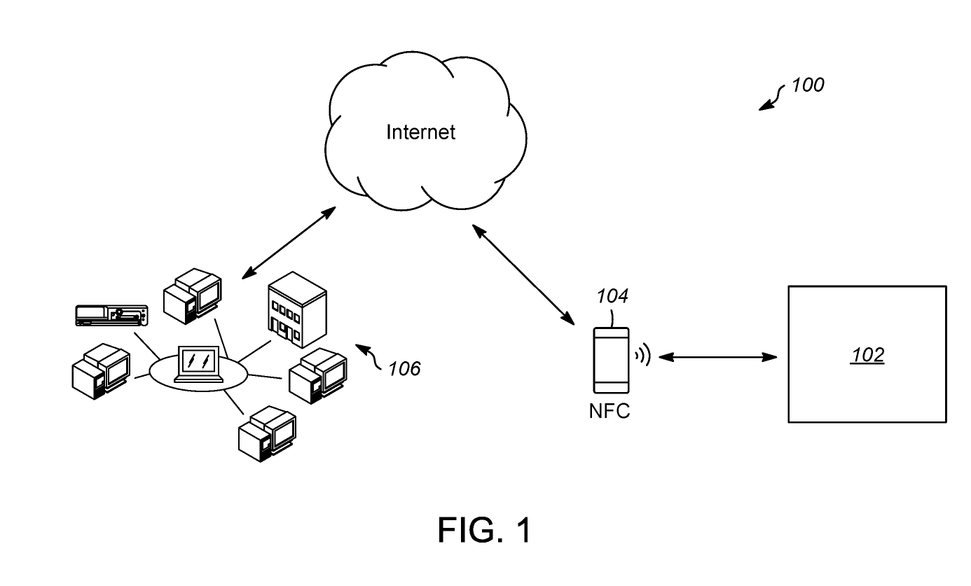

FIG. 1 describes and illustrates aspects of a prepaid metering system 100. The prepaid metering system 100 may include a prepaid metering device 102, a mobile device 104, a utility head-end system (HES) 106 and a metering network.

The prepaid metering device (e.g. meter) 102 may be part of the metering network in which the processes, systems, and apparatus disclosed herein may be employed. The metering network may comprise a plurality of meters 102, which are operable to sense and record consumption or usage of a service or commodity. Meters 102 may be located at customer premises, such as a home or place of business. Meters 102 comprise circuitry for measuring the consumption of the service or commodity being consumed at their respective locations and for generating data reflecting the consumption, as well as other data related thereto. Meters 100 may also comprise circuitry for wirelessly transmitting data generated by the meter to a remote location. Meters 102 may further comprise circuitry for receiving data, commands or instructions wirelessly as well. Meters that are operable to both receive and transmit data may be referred to as “two-way” meters, while meters that are only capable of transmitting data may be referred to as “transmit-only” or “one-way” meters. In bi-directional meters, the circuitry for transmitting and receiving may comprise a transceiver.

The meter 102 may be installed at a utility customer location. The meter 102 may be connected to one or more electrical loads at the customer location. The meter 102 may include a meter cover configured to measure and indicate the amount of energy consumption at a customer location, such as a residence, industry or business.

The meter 102 may include a low range wireless interface such as a tag. The tag may be configured for bidirectional communication between the mobile device 104 and the meter 102. The tag may aid in the “top up” of the energy at the meter 102. The tag may be a radio frequency identification (RFID) tag, such as a near field communication (NFC) tag. The tag may contain electronically stored identification information that is unique to tag and may be identified by using radio waves. The tag may contain an induction coil (not shown), that through excitation generated by a variable electromagnetic field generated by a mobile device 104, powers a small circuit (not shown) that is read by the mobile device 104 through RF waves. In one embodiment, the tag comprises an NFC tag, which is a subset of RFID tags. In one embodiment, the tag is a passive device. In other embodiments, the tag may be an active device.

A benefit of using the low range wireless interface is that it enables access to the meter 102 without having to power up the meter 102, by using a mobile application on the mobile device 104. The low range wireless interface also enables the mobile device 104 to retrieve various classes of meter data objects managed at distinct security levels while maintaining data integrity and security.

The meter 102 may also include an optional communications interface configured to communicate with the head-end system 106. The optional communications interface may be a two-way communications interface to the head-end system 106 and may comprise any suitable communications interface technology, such as a radio frequency (RF) transceiver, or an interface to the telephone lines or power lines at a meter location (e.g. customer location), etc. The optional communication interface may communicate with the head-end system 106 via a communications link. The communications link may be a private or public network, such as a subnet/LAN. The head-end system 106 may send and receive commands to and from the meter 102. In response to a command, the meter 102 may, for example, connect or disconnect the meter 102 by operating a disconnect switch to an open or close position.

Meters 102 may also include a processor, such as a microprocessor, microcontroller, or the like, a memory, and sensors. The processor may be operatively coupled to the sensors, the memory, the optional communications interface, and the low range wireless interface. The processor may be configured to receive signals from the sensors, the memory, the optional communications interface, and the low range wireless interface, to process the signals, and to store the signals in memory.

The mobile device 104 may include a graphical user interface (GUI) and/or a physical interface portion, such as a keypad, touch pad, and/or touch screen. The mobile application may be stored in a memory of the mobile device 104. The mobile application may be configured to store and manage meter 102 data, make payments to the meter 102, send meter 102 data to the head-end system 106, or still other functions. The mobile application may interact with the wireless interface tag by a “tap” of the mobile device 104 around a set point on the meter 102. The “tap” may, for example, transfer credit to the meter 102 or retrieve public, private, or encrypted data objects from the meter 102. The credit may be stored in the memory of the meter 102 and also sent to the head-end system 106.

The mobile application enables the user to view statistical information on energy usage and thereby provide guidance in effective management of the energy. The mobile application may retrieve the meter information from the wireless interface tag. The mobile application may require a password to access. The application may have different levels of access for different users. For instance, a utility technician may have access to additional features and be able to control aspects of the meter 102 that a customer does not have access to or is not able to control.

The application, along with wireless data connectivity for communication with the head-end system 106, can push configurable parameter registry values and events from the meter objects via the public data network infrastructure.

The application, along with GPS coordinate mapping, may provide the location information of the meter 102 at the location of installation to the head-end system 106 for diagnostics and monitoring of the meter 102.

The head-end system 106 may include remote servers 110 that are configured to execute dynamic learning algorithms based on installed base consumption trends and aid the end user in effective management of procured energy.

The mobile application may render options for a utility technician to verify the functional operation of the meter 102 during an installation process. For example, the utility technician selects a meter 102 to install at a location. Prior to transporting the meter 102 to the meter location, the technician may verify the meter 102 is working properly by “tapping” his mobile device 104 to the meter 102 to retrieve meter parameters, such as FWrev, contactor, register, or other meter parameters. If the meter 102 is working properly, the technician can transport the meter 102 to the meter location. If the meter 102 is not working properly, the technician may select another meter 102. The meter 102 may then be installed into a meter socket at the customer location. After the meter 102 is installed, the technician may “tap” the meter 102 again to make sure it is functioning properly. For example, the mobile application may receive rates, credits, or other meter status from the meter 102 that the technician can verify. The meter status is uploadable, via the metering network, to the head-end system 106.

The meter 102 may also be registered during installation. For example, the location information of the meter 102 may be sent to the head-end system 106. Registering the location information during installation may aid the utility to take immediate action in case of an event (e.g. tamper).

The mobile application may also enable a user to add credit to the meter account of the meter 102. A customer may notice that the meter 102 is displaying a low/zero credit. The meter 102 may include an audible alarm or other alarm to indicate a low/zero credit. The customer may login to the mobile application using a customer password, and add credit to the account. The credit transfer may be performed by “tapping” the meter 102 with the mobile device 104. The mobile application may then acknowledge a successful transfer and send the meter information to the head-end system 106 for data processing.

When adding credit to the meter account, the low range wireless interface on the meter 102 may receive payment credentials from the mobile application to add the credit to the meter 102. A payment credential may include any item, number, symbol, or other identifier associated with a mode of payment. Examples of payment credentials include an identifier associated with a prepaid unit of electricity, an identifier associated with a payment instrument (e.g. credit card, credit card number, bank account number, check, etc.), or an identifier associated with a customer account (user ID, password, etc.).

In response to meter information transmitted by the mobile application to the head-end system 106, the head-end system 106 may update the meter credit or other account settings for the meter 102.

The mobile application may also provide indications to the customer regarding average power and credit consumption per day for budget planning. The metering system 100 may monitor and diagnose through a remote diagnostic system that receives customer information during every “tap” of the mobile device 104 with the meter 102.

The metering system 100 enables the meter data read out process through the end user mobile device 104 and public infrastructure for communications via data connectivity.

The metering system 100 also enables credit to be shared between meters 102. For example, if two neighbors each have a prepaid meter 102, and neighbor A has extra meter credit, the meter credit may be shared with neighbor B by tapping neighbor A's mobile device 104 with neighbor B's meter. Another process of credit transfer could include entering in a meter serial number of neighbor B into the mobile application of neighbor A. Another process of credit transfer could be generating a unique code by the mobile application of neighbor A, and sharing the unique code with neighbor B who can enter the unique code into his mobile application and tap the meter 102 at neighbor B's meter location.

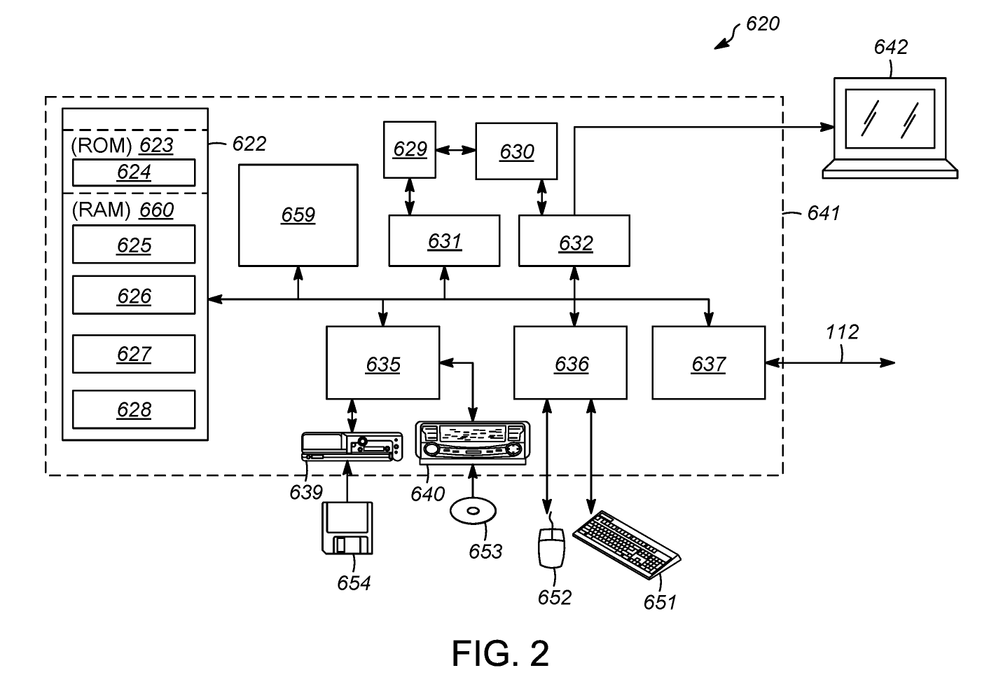

FIG. 2 is an example embodiment of a computing environment 620 of which various aspects of the metering system 100 could be implemented. For example, the computing environment 620 may be used to implement a data collection server, or any other aspect of the disclosed system that requires computing. The computing environment 620 is only one example of a suitable computing environment and is not intended to suggest any limitation as to the scope of use or functionality of the presently disclosed subject matter. Neither should the computing environment 620 be interpreted as having any dependency or requirement relating to any one or combination of components illustrated in FIG. 2. In some embodiments, the various depicted computing elements may include circuitry configured to instantiate specific aspects of the present disclosure. For example, the term circuitry used in the disclosure can include specialized hardware components configured to perform function(s) by firmware or switches. In other example embodiments, the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since the state of the art has evolved to a point where there is little difference between hardware, software, or a combination of hardware/software, the selection of hardware versus software to effectuate specific functions is a design choice left to an implementer. More specifically, a software process can be transformed into an equivalent hardware structure, and a hardware structure can itself be transformed into an equivalent software process. Thus, the selection of a hardware implementation versus a software implementation is one of design choice and left to the implementer.

In FIG. 2, the computing environment 620 comprises a computer 641. The computer 641 may be, for example, the mobile device 104. The computer 641 comprises a processing unit(s) 659, which may comprise a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processing unit(s) 659 may perform signal coding, data processing, power control, input/output processing, and/or any other functionality that enables the computing environment 620 to operate in accordance with its intended functionality. The computer 641 may further comprise a graphics interface, graphics processing unit (GPU), video memory 630, and video interface. These components may cooperate to display graphics and text on a video monitor, such as monitor 642. Processing unit(s) 659 and GPU 629 may receive, generate, and process data related to the processes and apparatuses disclosed herein.

In operation, processing unit(s) 659 fetches, decodes, and executes instructions, and transfers information to and from other resources via the computer's main data-transfer path, system bus 621. Such a system bus connects the components in computer 641 and defines the medium for data exchange. System bus 621 typically includes data lines for sending data, address lines for sending addresses, and control lines for sending interrupts and for operating the system bus. An example of such a system bus 621 is the PCI (Peripheral Component Interconnect) bus. A system memory 622 includes computer storage media in the form of volatile and/or nonvolatile memory such as read only memory (ROM) 623 and RAM 660. A basic input/output system 624 (BIOS), containing the basic routines that help to transfer information between elements within computer 641, such as during start-up, is typically stored in ROM 623. RAM 660 typically contains data, data tables, and/or program modules that are immediately accessible to and/or presently being operated on by processing unit 659.

The computer 641 may also include other removable/non-removable, volatile/nonvolatile computer storage media. By way of example only, the computer 641 may include a hard disk drive (not shown) that reads from or writes to non-removable, nonvolatile magnetic media, a magnetic disk drive 639 that reads from or writes to a removable, nonvolatile magnetic disk 654, and an optical disk drive 640 that reads from or writes to a removable, nonvolatile optical disk 653 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. Magnetic disk drive 639 and optical disk drive 640 are typically connected to the system bus 621 by a removable memory interface, such as interface 635. The drives and their associated computer storage media discussed above and illustrated in FIG. 2, provide storage of computer readable instructions, data structures, program modules and other data for the computer 641.

A user may enter commands and information into the computer 641 through input devices such as a keyboard 651 and pointing device 652, commonly referred to as a mouse, trackball or touch pad. Other input devices (not shown) may include a microphone, joystick, game pad, satellite dish, scanner, or the like. These and other input devices are often connected to the processing unit 659 through a user input interface 636 that is coupled to the system bus, but may be connected by other interface and bus structures, such as a parallel port, game port or a universal serial bus (USB). The computer may connect to a local area network or wide area network, such as network 112, through a network interface or adapter 637.

Thus, it is understood that any or all of the apparatuses, systems, processes and processes described herein may be embodied in the form of computer executable instructions (i.e., program code) stored on a computer-readable storage medium which instructions, when executed by a processor, such as processing unit(s) 659, cause the processor to perform and/or implement the systems, processes and processes described herein. Specifically, any of the steps, operations or functions described herein may be implemented in the form of such computer executable instructions, executing on the processor of a computing system or other computing apparatus. Computer readable storage media include both volatile and nonvolatile, removable and non-removable media implemented in any non-transitory (i.e., tangible or physical) process or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which can be used to store the desired information and which can be accessed by a computing system.

Any of the above lines, conduits, units, devices, vessels, surrounding environments, zones or similar may be equipped with one or more monitoring components including sensors, measurement devices, data capture devices or data transmission devices. Signals, process or status measurements, and data from monitoring components may be used to monitor conditions in, around, and on process equipment. Signals, measurements, and/or data generated or recorded by monitoring components may be collected, processed, and/or transmitted through one or more networks or connections that may be private or public, general or specific, direct or indirect, wired or wireless, encrypted or not encrypted, and/or combination(s) thereof; the specification is not intended to be limiting in this respect.

Signals, measurements, and/or data generated or recorded by monitoring components may be transmitted to one or more computing devices or systems. Computing devices or systems may include at least one processor and memory storing computer-readable instructions that, when executed by the at least one processor, cause the one or more computing devices to perform a process that may include one or more steps. For example, the one or more computing devices may be configured to receive, from one or more monitoring component, data related to at least one piece of equipment associated with the process. The one or more computing devices or systems may be configured to analyze the data. Based on analyzing the data, the one or more computing devices or systems may be configured to determine one or more recommended adjustments to one or more parameters of one or more processes described herein. The one or more computing devices or systems may be configured to transmit encrypted or unencrypted data that includes the one or more recommended adjustments to the one or more parameters of the one or more processes described herein.

Benefits of the metering system include:
Solutions can be easily extended to electricity, gas, and water metering business as well as providing a battery-free/powerless automatic read-out.
The metering system is based on upcoming energy metering product—SMETS2.
Automated prepaid solution with enhanced user experience—to collect metering information and make payments for energy.
Makes it easier for households to control their energy costs.
Allows utility companies to monitor for lost revenue and save operation cost on manual meter reading process.
Shift in smart metering from “cyclic read-out” to “end-user driven read-out.”
Shift from proprietary communication infrastructure to public but secured networks.

While the disclosure is described herein using a limited number of embodiments, these specific embodiments are for illustrative purposes and are not intended to limit the scope of the disclosure as otherwise described and claimed herein. Modification and variations from the described embodiments exist. The scope of the invention is defined by the appended claims.

### Specific Embodiments

While the following is described in conjunction with specific embodiments, it will be understood that this description is intended to illustrate and not limit the scope of the preceding description and the appended claims.

A first embodiment of the invention is a process for confirming installation of a prepaid metering device, the process comprising prior to installation of the metering device, detecting a first status of the metering device through a wireless interface between a mobile device and the metering device, wherein the mobile device includes a mobile application that receives the first status of the metering device; determining a first condition of the metering device based on the first status; installing the metering device at a meter location; after installation of the metering device, detecting a second status of the metering device through the wireless interface between the mobile device and the metering device, wherein the mobile application receives the second status of the metering device; determining a second condition of the metering device based on the second status; and transmitting the second condition of the metering device to a utility head-end system via the mobile application. An embodiment of the invention is one, any or all of prior embodiments in this paragraph up through the first embodiment in this paragraph, wherein the mobile application requires a password to access. An embodiment of the invention is one, any or all of prior embodiments in this paragraph up through the first embodiment in this paragraph, further comprising registering the meter location of the metering device, wherein registering the meter location comprises transmitting the meter location to the utility head-end system via the mobile application. An embodiment of the invention is one, any or all of prior embodiments in this paragraph up through the first embodiment in this paragraph, further comprising adding a credit to the metering device by the mobile application. An embodiment of the invention is one, any or all of prior embodiments in this paragraph up through the first embodiment in this paragraph, further comprising transmitting a command to the metering device to disconnect if the second condition is a tamper event. An embodiment of the invention is one, any or all of prior embodiments in this paragraph up through the first embodiment in this paragraph, wherein the metering device includes a low range wireless communication device, wherein the wireless device detects the first status and the second status via a wireless communication between the mobile application and the low range wireless communication device. An embodiment of the invention is one, any or all of prior embodiments in this paragraph up through the first embodiment in this paragraph, further comprising at least one of sensing at least one parameter of the process and generating a signal or data from the sensing; generating and transmitting a signal; or generating and transmitting data.

A second embodiment of the invention is a system for confirming installation of a prepaid metering device, the system comprising a metering device; a mobile device; a wireless interface between the mobile device and the metering device; and a utility head-end system via the mobile application. An embodiment of the invention is one, any or all of prior embodiments in this paragraph up through the second embodiment in this paragraph, wherein prior to installation of the metering device, there is detection of a first status of the metering device through a wireless interface between a mobile device and the metering device, wherein the mobile device includes a mobile application that receives the first status of the metering device. An embodiment of the invention is one, any or all of prior embodiments in this paragraph up through the second embodiment in this paragraph, wherein there is a determining of a first condition of the metering device based on the first status. An embodiment of the invention is one, any or all of prior embodiments in this paragraph up through the second embodiment in this paragraph, wherein the metering device is installed at a meter location. An embodiment of the invention is one, any or all of prior embodiments in this paragraph up through the second embodiment in this paragraph, wherein after installation of the metering device, detecting a second status of the metering device through the wireless interface between the mobile device and the metering device, wherein the mobile application receives the second status of the metering device. An embodiment of the invention is one, any or all of prior embodiments in this paragraph up through the second embodiment in this paragraph, wherein the metering device determines a second condition of the metering device based on the second status. An embodiment of the invention is one, any or all of prior embodiments in this paragraph up through the second embodiment in this paragraph, wherein a determination of a second condition of the metering device based on the second status is made; and a transmission of the second condition of the metering device to a utility head-end system via the mobile application. An embodiment of the invention is one, any or all of prior embodiments in this paragraph up through the second embodiment in this paragraph, wherein the mobile application requires a password to access. An embodiment of the invention is one, any or all of prior embodiments in this paragraph up through the second embodiment in this paragraph, further comprising registering the meter location of the metering device, wherein registering the meter location comprises transmitting the meter location to the utility head-end system via the mobile application. An embodiment of the invention is one, any or all of prior embodiments in this paragraph up through the second embodiment in this paragraph, further comprising adding a credit to the metering device by the mobile application. An embodiment of the invention is one, any or all of prior embodiments in this paragraph up through the second embodiment in this paragraph, further comprising transmitting a command to the metering device to disconnect if the second condition is a tamper event. An embodiment of the invention is one, any or all of prior embodiments in this paragraph up through the second embodiment in this paragraph, wherein the metering device includes a low range wireless communication device, wherein the wireless device detects the first status and the second status via a wireless communication between the mobile application and the low range wireless communication device. An embodiment of the invention is one, any or all of prior embodiments in this paragraph up through the second embodiment in this paragraph, further comprising at least one of a sensor positioned at a location to sense at least one parameter; a transmitter; and a computing device.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims. In the foregoing, all temperatures are set forth in degrees Celsius and, all parts and percentages are by weight, unless otherwise indicated.

1. A process for confirming installation of a prepaid metering device, the process comprising:
prior to installation of the metering device, detecting a first status of the metering device through a wireless interface between a mobile device and the metering device, wherein the mobile device includes a mobile application that receives the first status of the metering device;
determining a first condition of the metering device based on the first status;
installing the metering device at a meter location;
after installation of the metering device, detecting a second status of the metering device through the wireless interface between the mobile device and the metering device, wherein the mobile application receives the second status of the metering device;
determining a second condition of the metering device based on the second status; and
transmitting the second condition of the metering device to a utility head-end system via the mobile application.

2. The process of claim 1, wherein the mobile application requires a password to access.

3. The process of claim 1, further comprising registering the meter location of the metering device, wherein registering the meter location comprises transmitting the meter location to the utility head-end system via the mobile application.

4. The process of claim 1, further comprising adding a credit to the metering device by the mobile application.

5. The process of claim 1, further comprising transmitting a command to the metering device to disconnect if the second condition is a tamper event.

6. The process of claim 1, wherein the metering device includes a low range wireless communication device, wherein the wireless device detects the first status and the second status via a wireless communication between the mobile application and the low range wireless communication device.

7. The process of claim 1, further comprising at least one of:
sensing at least one parameter of the process and generating a signal or data from the sensing;
generating and transmitting a signal; or
generating and transmitting data.

8. A system for confirming installation of a prepaid metering device, the system comprising:
a metering device;
a mobile device;
a wireless interface between the mobile device and the metering device; and
a utility head-end system via the mobile application.

9. The system of claim 8, wherein prior to installation of the metering device, there is detection of a first status of the metering device through a wireless interface between a mobile device and the metering device, wherein the mobile device includes a mobile application that receives the first status of the metering device.

10. The system of claim 8, wherein there is a determining of a first condition of the metering device based on the first status.

11. The system of claim 8, wherein the metering device is installed at a meter location.

12. The system of claim 8, wherein after installation of the metering device, detecting a second status of the metering device through the wireless interface between the mobile device and the metering device, wherein the mobile application receives the second status of the metering device.

13. The system of claim 8, wherein the metering device determines a second condition of the metering device based on the second status.

14. The system of claim 8, wherein a determination of a second condition of the metering device based on the second status is made; and a transmission of the second condition of the metering device to a utility head-end system via the mobile application.

15. The system of claim 8, wherein the mobile application requires a password to access.

16. The system of claim 8, further comprising registering the meter location of the metering device, wherein registering the meter location comprises transmitting the meter location to the utility head-end system via the mobile application.

17. The system of claim 8, further comprising adding a credit to the metering device by the mobile application.

18. The system of claim 8, further comprising transmitting a command to the metering device to disconnect if the second condition is a tamper event.

19. The system of claim 8, wherein the metering device includes a low range wireless communication device, wherein the wireless device detects the first status and the second status via a wireless communication between the mobile application and the low range wireless communication device.

20. The system of claim 8, further comprising at least one of:
a sensor positioned at a location to sense at least one parameter;
a transmitter; and
a computing device.
